(19) United States
(12) Patent Application Publication
(10) Pub. No.: US 2016/0203108 A1
(43) Pub. Date: Jul. 14, 2016

(54) DISPLAY SCALING APPLICATION

(71) Applicant: SMUGMUG, INC., Mountain View, CA (US)

(72) Inventors: Brian STRONG, San Jose, CA (US); Don MACASKILL, Los Altos, CA (US)

(73) Assignees: SMUGMUG, INC., Mountain View, CA (US); SMUGMUG, INC., Mountain View, CA (US)

(21) Appl. No.: 14/912,581

(22) PCT Filed: Sep. 2, 2014
(86) PCT No.: PCT/US2014/053701

§ 371 Date: Feb. 17, 2016

Related U.S. Application Data
(60) Provisional application No. 61/874,754, filed on Sep. 6, 2013.

(51) Int. Cl. G06F 17/21; G06F 17/30

(52) U.S. Cl. CPC G06F 17/212; G06F 17/30905

(57) ABSTRACT

Embodiments described herein generally relate to a dynamic display scaling application. The display scaling application adapts to content displayed within a graphical user interface (GUI) to provide an aesthetically pleasing website. By automatically analyzing the metadata of content to be displayed in a website and applying a heuristic analysis based on the metadata, the display scaling application automatically displays content within a website in the most aesthetically pleasing and efficient manner.

### BACKGROUND

1. Field

Embodiments described herein generally relate to a method of displaying content in a website. More specifically, embodiments provided herein relate to a display scaling application.

2. Description of the Related Art

The Internet has gained prevalence in today's society enjoyed by few other technologies. The backbone of the Internet is the almost countless number of websites that can be accessed from the Internet by users around the world. Many businesses and individuals maintain a website for business or personal use. The evolution of websites has resulted in a demand from website viewers that the websites function properly and are aesthetically pleasing. Often times, a website may be the face of a business and the impression formed on the website viewer when viewing the website may help form the viewer's attitude toward the business.

A user may maintain a website for various purposes and may desire to update the website from time to time. However, an original website design may not readily adapt to rearrangement of content already in the website or content the user wants to add to the website. Content may be almost any type of media and may contain characteristics which do not allow the content to be easily aesthetically integrated into the website. For example, a portrait photograph displayed amongst numerous landscape photographs may be displayed with dead areas (areas where no content is displayed) on either side of the portrait photograph. The dead areas not only hurt the appearance of the content displayed in the website, but also reduce the usable display area within the website. Although content with varying characteristics may be displayed in the website, the website may look unprofessional and hobbled together which will likely reduce the aesthetic qualities of the website.

A user may rearrange content or add new content to the website so that the website is aesthetically pleasing, however, this process may be very time consuming because the user must ensure that each item of new content coordinates with content already contained in the website and with additional new content items. The user must then make design changes in the website to accommodate the new content before the website is acceptable for viewing. Each time the user desires to upload new content or rearrange content already present in the website, the same process must be performed, thus, reducing the efficiency of maintaining a website.

Moreover, when a website is viewed on different browsers and various devices, such as desktop computers or mobile phones, the display of the website may not be acceptable for each browser or device. Thus, the aesthetic qualities of the website may be reduced.

Therefore, what is needed in the art is an application for automatically scaling content for display within a website.

### SUMMARY

In one embodiment, a method of performing display scaling is provided. The method may comprise receiving input regarding content to be displayed in a website having a content area, analyzing metadata of the content after receiving the input, determining characteristics of the content based on the metadata, and applying a heuristic analysis of the characteristics. The heuristic analysis may comprise determining a layout of the content to be displayed on the website that results in multiple content items to be displayed that have different sizes and/or orientations without altering the size and/or orientation of the content items and while utilizing greater than about 95 percent of the content area. The method may also comprise displaying the content in the website.

In another embodiment, a non-transitory computer readable storage medium may be provided. The non-transitory computer readable storage medium may store instructions that when executed by a processor, cause the processor to provide display scaling by performing the steps of receiving input regarding content to be displayed in a website having a content area, analyzing metadata of the content after receiving the input, determining characteristics of the content based on the metadata, and applying a heuristic analysis of the characteristics. The heuristic analysis may comprise determining a layout of the content to be displayed on the website that results in multiple content items to be displayed that have different sizes and/or orientations without altering the size and/or orientation of the content items and while utilizing greater than about 95 percent of the content area. The steps may also include displaying the content in the website.

In yet another embodiment, a computer system for providing display scaling may be provided. The computer system may comprise a processor and a memory. The memory may store instructions that, when executed by the processor, cause the computer system to receive input regarding content to be displayed in a website having a content area, analyze metadata of the content after receiving the input, determine characteristics of the content based on the metadata, and apply a heuristic analysis of the characteristics. The heuristic analysis may comprise determining a layout of the content to be displayed on the website that results in multiple content items to be displayed that have different sizes and/or orientations without altering the size and/or orientation of the content items and while utilizing greater than about 95 percent of the content area. The computer system may also display the content in the website.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a computer system configured for providing a website having a display scaling application.

FIG. 2 illustrates a more detailed view of a server of FIG. 1.

FIG. 3 illustrates a user computing system used to access a website and utilize a display scaling application.

FIG. 4 illustrates a conventional example of a graphic user interface (GUI) displaying a website with various types of content.

FIG. 5 illustrates examples of various types of content that may be displayed in a website.

FIGS. 6A-6C illustrate a website displaying webpages incorporating the content of FIG. 5.

FIGS. 7A and 7B illustrate a GUI being changed from a landscape orientation to a portrait orientation.

FIG. 8 illustrates a schematic flow chart illustrating a display scaling application receiving input and displaying content within a website.

To facilitate understanding, identical reference numerals have been used, where possible, to designate identical elements that are common to the figures. It is contemplated that elements disclosed in one embodiment may be beneficially utilized in other embodiments without specific recitation.

### DETAILED DESCRIPTION

Embodiments described herein generally relate to a dynamic display scaling application. The display scaling application adapts to content displayed within a graphical user interface (GUI) to provide an aesthetically pleasing website. By automatically analyzing the metadata of content to be displayed in a website and applying a heuristic analysis based on the metadata, the display scaling application automatically displays content within a website in the most aesthetically pleasing and efficient manner.

The term “user” as used herein includes, for example, a person or entity that owns a computing device or a wireless device; a person or entity that operates or utilizes a computing device or a wireless device; or a person or entity that is otherwise associated with a computing device or a wireless device. It is contemplated that the term “user” is not intended to be limiting and may include various examples beyond those described.

The term “metadata” as used herein includes, for example, technical characteristics, such as aspect ratio, image type, camera type, lens type, pixels per photo, resolution, display pixel density, shutter speed, f stop, iso, color balance, manufacturer data; event/transactional characteristics, such as digital watermarking and non-destructive editing data; derived characteristics, such as metadata derived by interpreting existing metadata or calculating new metadata; descriptive/classification characteristics, such captions, keywords, location, image categories, etc; automation characteristics, segmentation characteristics; security characteristics; discovery characteristics; history characteristics; business characteristics; and process characteristics. Metadata may be embedded in content or similarly attached to content. It is contemplated that the term “metadata” is not intended to be limiting and may include various examples beyond those described.

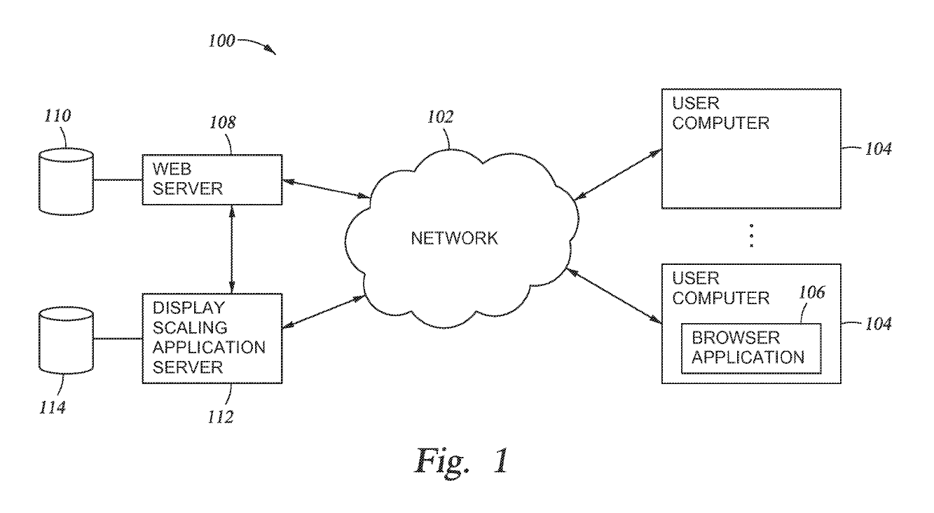

FIG. 1 illustrates a computer system configured for providing a display scaling application. As shown, the computing system 100 may include a web server 108, a display scaling application server 112, and a plurality of user computers 104 (only two of which are shown for clarity), each connected to a communications network 102 (e.g. the Internet). For example, the web server 108 may be programmed to communicate with the user computers 104 and the display scaling application server 112 using a networking protocol such as TCP/IP protocol. The display scaling application server 112 may communicate directly with the user computers 104 through the communications network 102.

Each user computer 104 may include conventional components of a computing device, e.g., a processor, system memory, a hard disk drive, input devices such as a mouse and a keyboard, and/or output devices such as a monitor, and/or a combination input/output device such as a touchscreen which not only receives input but also displays an output. The web server 108 and the display scaling application server 112 may include a processor and a system memory (not shown), and may be configured to manage web pages and other media content stored in its respective content storage unit 110 and 114 using a file system and/or relational database software. The display scaling application server 112 may be a web server configured to manage content metadata and heuristic characteristics stored in its respective content storage unit 114. The display scaling application server 112 may be configured to receive input from a user, such as rearranging content or adding content to user's website and automatically scale and arrange the content within the website in an efficient and aesthetically pleasing manner.

In the embodiments described below, users are respectively operating the user computers 104 that may communicate over the network 102 to request webpages and other media content data from the display scaling application server 112. Each user computer 104 may be configured to execute a software application, such as a browser application 106, and access webpages and/or media content data managed by the display scaling application server 112 by specifying a uniform resource locator (URL) for the display scaling application server 112 into the web browser application 106. The webpages that are displayed to a user may be transmitted from the display scaling application server 112 to the user's computer 104 and processed by the web browser application 106 for display through a GUI of the user's computer 104.

In one example, a webpage displayed on the user's computer 104 may be the user's own customized website. The user's computer 104 may access the display scaling application server 112 which, in turn, retrieves the user's website from storage 114, and causes the user's website to be shown through the browser 106 on the user's computer 104 in an efficient and aesthetically pleasing manner. The user's website may be managed by the user with a username and password combination, or other similar restricted access/verification required access methods, which allow the user to “log in” and make changes within the website. Changes or alterations made by the user to their website on the user computer 104 may be transmitted through the communications network 102 to the display scaling application server 112. The display scaling application server 112 may transfer the user's website to storage 114 where it may be retrieved and viewed by any other users with access to the Internet. It is contemplated that the webpage displayed may also be any webpage accessed by the user. Thus, the display scaling application described below may be applicable to various types of websites and even software.

It is noted that the user computer 104 may be a personal computer, laptop, mobile computing device, smart phone, video game console, home digital media player, network-connected television, set top box, and/or other computing devices having components suitable for communicating with the communications network 102. The user computer 104 may also execute other software applications configured to receive website content and display scaling information from the display scaling application server 112, such as, but not limited to, metadata, heuristics, media display software, media players, computer and video games, and/or widget platforms.

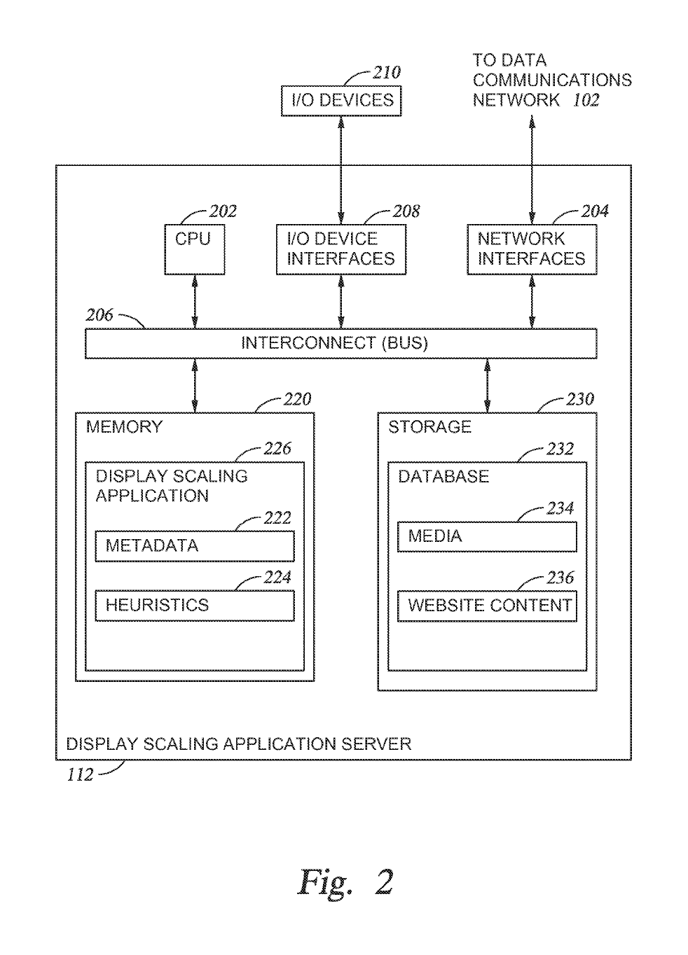

FIG. 2 illustrates a more detailed view of the display scaling application server 112 of FIG. 1. The display scaling application server 112 includes, without limitation, a central processing unit (CPU) 202, a network interface 204, memory 220, and storage 230 communicating via an interconnect bus 206. The display scaling application server 112 may also include I/O device interfaces 208 connecting I/O devices 210 (e.g., keyboard, video, mouse, audio, touchscreen, etc). The display scaling application server 112 may further include a network interface 204 configured to transmit data via the communications network 102.

The CPU 202 retrieves and executes programming instruction stored in the memory 220 and generally controls and coordinates operations of other system components. Similarly, the CPU 202 stores and retrieves application data residing in the memory 220. The CPU 202 is included to be representative of a single CPU, multiple CPU's, a single CPU having multiple processing cores, and the like. The interconnect 206 is used to transmit programming instructions and application data between the CPU 202, I/O device interfaces 208, storage 230, network interface 204, and memory 220.

The memory 220 is generally included to be representative of a random access memory and, in operation, stores software applications and data for use by the CPU 202. Although shown as a single unit, the storage 230 may be a combination of fixed and/or removable storage devices, such as fixed disk drives, floppy disk drives, hard disk drives, flash memory storage drives, tape drives, removable memory cards, CD-ROM, DVD-ROM, Blu-Ray, HD-DVD, optical storage, network attached storage (NAS), or a storage area-network (SAN) configured to store non-volatile data.

The memory 220 may store instructions and logic for executing a display scaling application 226. The display scaling application 226 may include analytic information, such as metadata 222 and heuristics 224, among other applications. The storage 230 may store website building content and help instructions and may include a database 232 configured to store data for displaying a website with associated instructions according to techniques described herein, such as media content 234 and website content 236. The database 232 may also store data relating to display characteristics for providing the user with a website that displays content in an efficient and aesthetically pleasing manner. The database 232 may be any type of storage device.

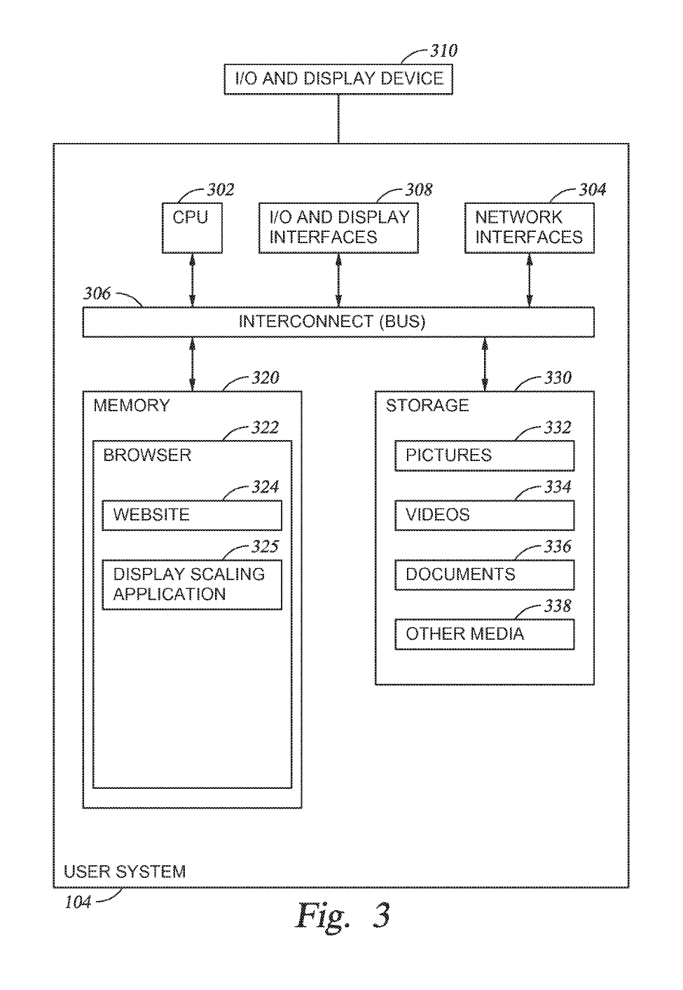

FIG. 3 illustrates a user computing system used to access the display scaling application server within a website, such as the users own website. The user computing system 104 may include, without limitation, a central processing unit (CPU) 302, a network interface 304, an interconnect 306, a memory 320, and storage 330. The computing system 104 may also include an I/O device interface 308 connecting I/O devices 310 (e.g. keyboard, display, touchscreen, and mouse devices) to the computing system 104.

Like CPU 202, CPU 302 is included to be representative of a single CPU, multiple CPU's, a single CPU having multiple processing cores, etc., and the memory 320 is generally included to be representative of a random access memory. The interconnect 306 may be used to transmit programming instructions and application data between the CPU 302, I/O device interfaces 308, storage 330, network interface 304, and memory 320. The network interface 304 may be configured to transmit data via the communications network 102, e.g. to stream content from the display scaling application server 112, as well as to receive and present the user's website with associated help instructions. Storage 330, such as a hard disk drive or solid-state storage drive (SSD), may store non-volatile data. The storage 330 may contain pictures 332, videos 334, documents 336, and other media 338 which can be any type of media that may be published to a website. Illustratively, the memory 320 may include a browser 322, which itself displays a website 324 with media arranged by a display scaling application 325. The browser 322 may provide a software application which allows the user to access web pages and other content hosted by the display scaling application server 112. The browser 322 may also allow any user of the user computer system 104 to access any website available on the Internet.

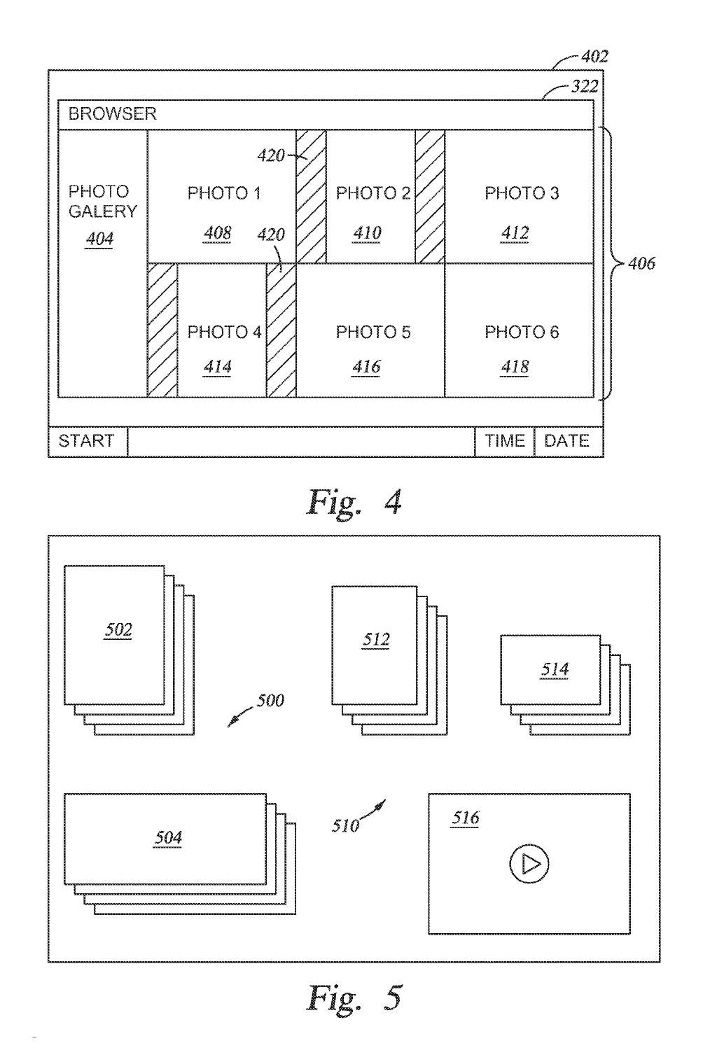

FIG. 4 illustrates a conventional example of a GUI 402 displaying a website 404 with various types of content. The GUI 402, such as a monitor or I/O device described above, may display to a user a website 404 within the browser 322. The website 404 may be user user's own website or a different website incorporating the display scaling application 325. Although shown and described with relation to a website for the sake of clarity, it is contemplated that the embodiments described herein may be applicable to any type of software or computer program. Content items, or tiles, 408, 410, 412, 414, 416, 418 displayed in the website 404 may be any type of content typically shown in a website. For example, the website 404 may display various types of content, such as photos in a photo gallery. The content items 408, 410, 412, 414, 416, 418 depicted in FIG. 4 may be content displayed in a content area 406 of the user's own customized website 404.

The content area 406 is illustratively shown as a grid for displaying photos having a landscape orientation. Although described with regard to photographs, any type of media content may displayed in a website may benefit from the display scaling application 325. The content area 406 is shown as being formatted to accommodate photos whose dimensions correlate to landscape orientation dimensions. A user may desire to provide content, such as photos, to the website 404 which comprise varying characteristics. The characteristics, simplified in this example, are photos in a landscape orientation and photos in a portrait orientation. Content items 408, 412, 416, 418 are photos having dimensions that fall within typical landscape orientation dimensions. However, content items 410, 414 are photos which have portrait orientation dimensions. The portrait orientation of the content items 410, 414 results in unintentional dead space 420 displayed adjacent the content items 410, 414 within the content area 406. For example, the user did not intend there to be dead space 420 when providing the content items 408, 410, 412, 414, 416, 418. The dead space 420 generally contains no content and not only looks undesirable in a photo gallery display, but also reduces the efficiency of the content area 406. The reduced efficiency of the content area 406 may result in fewer photos being displayed in the photo gallery and the photos not being displayed in an aesthetically pleasing manner in relation to other photos in the gallery.

FIG. 5 depicts examples of various types of content that may be displayed in a website. A first content group 500 may comprise one or more content items. A first content item 502 and a second content item 504 may have distinguishable characteristics. As depicted for the sake of simplicity, the first content item 502 may be a plurality of photos having a portrait orientation and the second content item 504 may be a plurality of photos having a landscape orientation. However, the characteristics between the first content item 502 and the second content item 504 may be distinguishable based upon numerous other factors contained in the metadata of the content items 502, 504. For example, metadata concerning the resolution of the photos, location where the photos were taken, descriptive phrases tagged to the photos, and the like may be used to distinguish the content items 502, 504.

A second content group 510 may comprise one or more content items. A third content item 512, a fourth content item 514, and a fifth content item 516 may be examples of content having distinguishable characteristics. For example, the third content item 512 may be one or more high resolution photos, the fourth content item 514 may be photos which have been edited in some fashion, such as having a filter applied to the photo, and the fifth content item 516 may be a video clip. The user may desire to provide the second content group 510 and/or the first content group 500 to the user's website 404. Each of the content items 502, 504, 512, 514, 516 may contain embedded metadata which may be utilized by the display scaling application 325 to distinguish and characterize the content items when the content items 502, 504, 512, 514, 516 are displayed in the user's website 404. The above examples are for illustration and should not be considered as limiting. Any form of metadata capable of distinguishing content may be analyzed by the display scaling application 325 which will be discussed in detail below.

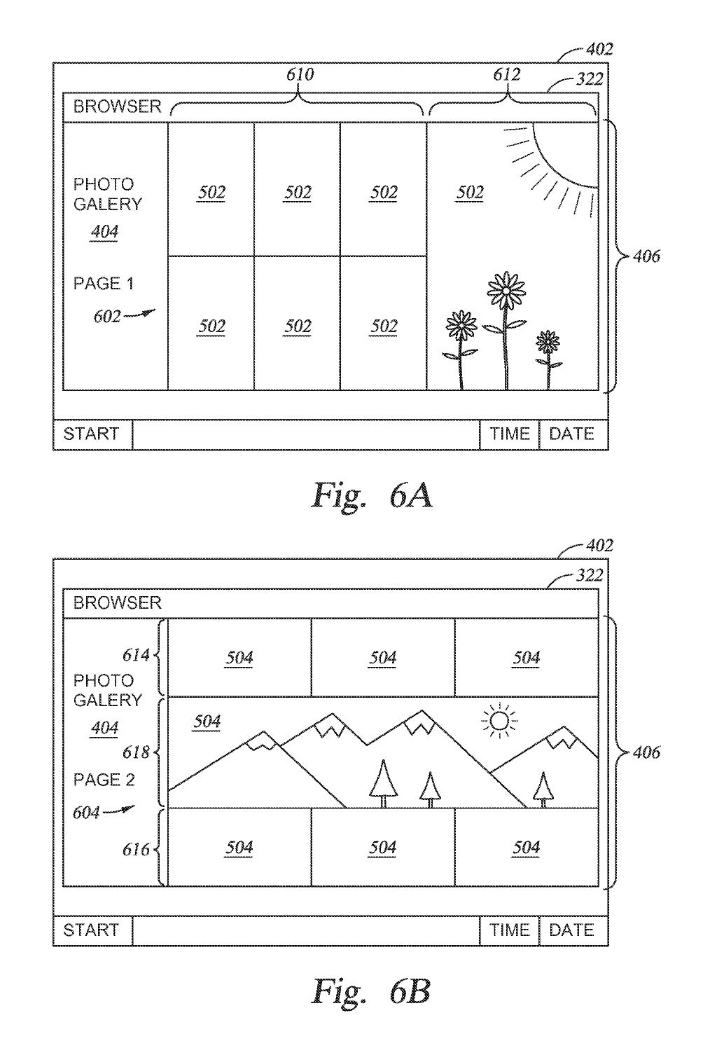

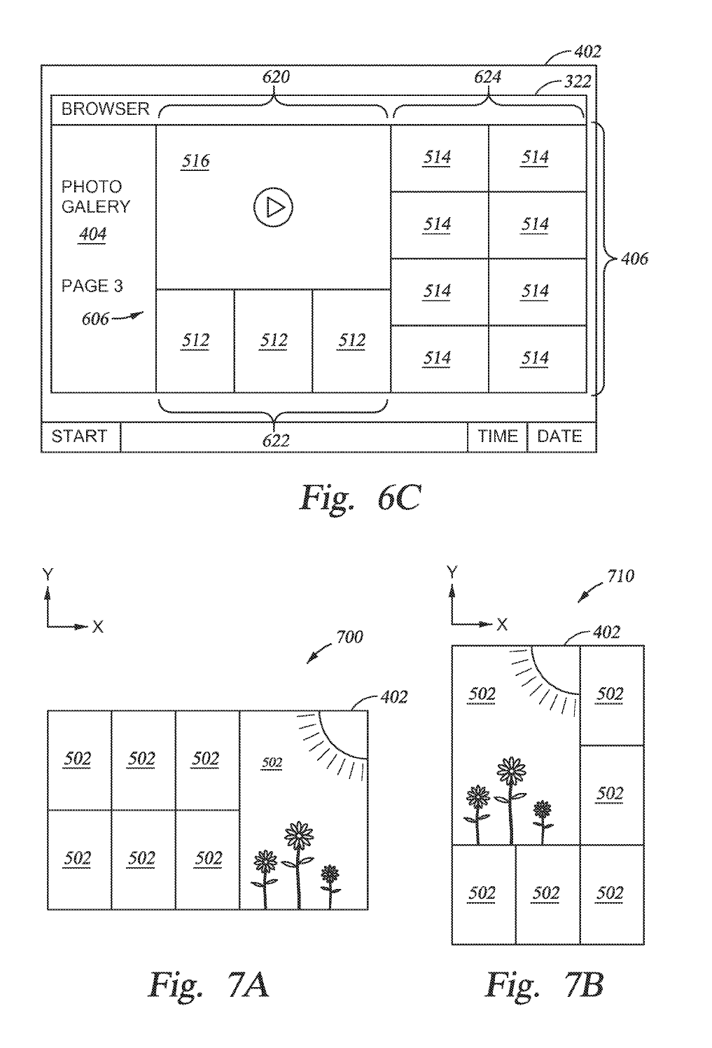

FIGS. 6A-6C depict the website 404 displaying gallery pages 602, 604, 606 of a photo gallery incorporating the first content group 500 and second content group 510 of FIG. 5. As previously described, the user may desire to rearrange or add content to the website 404. In this example, the user has provided the first content group 500 and the second content group 510 to the website 404. Upon providing the first content item 502 to the website, the display scaling application 325 automatically analyzes the metadata of the first content item 502 to determine the most efficient and aesthetically pleasing arrangement of the first content item 502 within the website 404. Similarly, the second, third, fourth, and fifth content items, 504, 512, 514, 516, respectively, may also be analyzed by the display scaling application 325 based upon embedded metadata of the content items.

In the example shown in FIG. 6A, the display scaling application 325 may automatically determine, based upon analysis of the metadata of the first content group 500 and the second content group 510, how to display the first content item 502 most efficiently in the first gallery page 602. In this example, the display scaling application 325 may determine from the metadata that all photos having dimensions suggesting a portrait orientation would display most efficiently when the portrait photos were provided together in a single page. Further, the display scaling application 325 may determine, via a heuristic analysis, that a thumbnail grid 610 and a single enlarged photo region 612 would provide the most aesthetically pleasing display when viewing the website 404 first gallery page 602.

The heuristic analysis may be based upon various factors related to website design so that content within the website 404 is displayed in a desirable manner. The heuristic analysis performed by the display scaling application 325 may comprise determining a layout of the content to the displayed on the webpage that results in multiple content items to be displayed that have different sizes and/or orientations without altering the size and/or orientation of the content items. The display scaling application 325 may also utilize greater than about 80 percent of the content area 406 to display content, such as greater than about 90 percent, and in certain examples, greater than about 95 percent. The high percentage of content area utilization may reduce the presence of unintentional dead space 420 and increase the efficiency and aesthetics of the content displayed in the website 404.

In this example, the display scaling application 325 intentionally excluded the second, third, fourth, and fifth content items, 504, 512, 514, 516, respectively, from being displayed in the first gallery page 602. As such, no dead space is contained in the first gallery page 602 because the portrait dimensions of the first content items 502 mesh seamlessly. Thus, the efficiency of the website 404 display may be increased and the content item 502 may be displayed in an aesthetically pleasing manner. It is contemplated that the arrangement of the first content item 502 within the first gallery page 602 is only an example, as other arrangements may also provide for an efficient and aesthetically pleasing display.

FIG. 6B depicts a second gallery page 604 displayed in the website 404. As described above, the first content group 500 and the second content group 510 have been provided for display within the photo gallery. The display scaling application 325 may provide the second content item 504 to be displayed on the second gallery page 604. The metadata of the second content item 504, photographs having dimensions in a landscape orientation, may be analyzed by the display scaling application 325 and format the second content item 504 accordingly on the second gallery page 604. As such, heuristic analysis performed on the second content item 504 by the display scaling application 325 may result in the second content item 504 being display in one or more thumbnail rows 614, 616, 618 and a single enlarged photograph. The resulting display of the second content item 504 may be more efficient (e.g., lack of dead space between individual photos) and provide desirable aesthetic qualities.

FIG. 6C depicts a third gallery page 606 displayed in the website 404. In this example, the display scaling application determined that the first content item 502 should be displayed in the first gallery page 602 and the second content item 504 should be displayed in the second gallery page 604. Here, the second content group 510 may be analyzed by the display scaling application 325 which may determine that the third content item 512, the fourth content item 514, and the fifth content item 516 may be displayed in an efficient and aesthetically pleasing manner in a single gallery page. In this example, the display scaling application 325 may analyze the metadata of each content item 512, 514, 516 of the second content group 510 and display them in the third gallery page 606 after heuristically analyzing the content group.

The fifth content item 516, a video, may be displayed in a prominent position and may occupy a first area 620 of the third gallery page 606 because a viewer of the website 404 would likely expect a video to display in a manner that would enhance the viewing experience. The first area 620 may be determined by the heuristic analysis performed by the display scaling application 325 upon analyzing the metadata of the second content group 510. Similarly, the display scaling application 325 may determine that the third content item 512, high resolution photos, may be displayed most efficiently and in an aesthetically pleasing manner if all of the high resolution photos are display adjacent each other. For example, a viewer of the website may expect to see all high resolution photos together and not scattered throughout the website 404 on different gallery pages. Here, the third content item 512 may occupy a second area 622 of the third gallery page 606.

The fourth content item 514, edited photos, may be displayed in a third area 624. The display of the fourth content item 514 may be determined by the display scaling application 325 based upon an analysis of the metadata contained within the fourth content item 514. The display scaling application 325 may also heuristically analyze the entire second content group 510 and determine that the second content group 510 should be displayed across the entire content area 406 of the third gallery page 606 without any dead space between the content items 512, 514, 516 of the second content group 510. The arrangement of the content items 512, 514, 516 within the third gallery page 606 is meant for illustrative purposes only, and not intended to be limiting as other arrangements may provide for an efficient and aesthetically pleasing display in the browser 322 content area 406.

Depending on the type and characteristics of content, the display scaling application 325 may heuristically analyze the entire set of metadata contained within the content to automatically format and display the content within the website 404. The arrangement of content in FIGS. 6A-6C is for illustrative purposes. It is contemplated that numerous other arrangements of content may also efficiently the content without dead spaces. Similarly, heuristic analysis may dynamically display content based upon various factors to provide an aesthetically pleasing content display. Further, the heuristic analysis may learn a user's preferred content display preferences and provide an arrangement of content which may reflect the user's preferences.

FIGS. 7A and 7B depict a GUI 402 being changed from a landscape orientation 700 to a portrait orientation 710. The landscape orientation 700 of FIG. 7A is depicted as displaying the first content item 502. In this example, six thumbnail pictures and a single large photo (flowers) are displayed in the GUI 402. The GUI 402 may be representative of a tablet or mobile device in the landscape orientation 700 or a browser window in any GUI 402 having dimensions which represent a landscape orientation.

A user may desire to change the orientation of the GUI 402 from the landscape orientation 700 to the portrait orientation 710 which is depicted in FIG. 7B. Upon receiving input from the user regarding the orientation change, the display scaling application 325 may automatically reflow the first content item 502 to be displayed in the GUI 402 in the portrait orientation. In this example, the single large photo and the thumbnails have been repositioned within the GUI 402 to provide a more efficient and aesthetically pleasing display which provides an improved portrait orientation 710 content display. As depicted, the large photo and five thumbnail pictures are displayed in the portrait orientation 710. The sixth thumbnail picture of the landscape orientation 700 may be viewed by receiving user input scrolling down to display the sixth thumbnail in the GUI 402. In an alternative embodiment, the sixth thumbnail may displayed in a separate webpage within the browser 322 being displayed on the GUI 402.

The display scaling application 325 may account for the fact that content displayed in the landscape orientation 700 may not be arranged in a manner suitable for display in the portrait orientation 710. For example, the landscape orientation 700 content display would not efficiently display in the portrait orientation 710, nor would the landscape orientation 700 of the content be aesthetically pleasing in the portrait orientation 710 if the arrangement of the content were not reflowed by the display scaling application 325. The reflowing of the content between various orientations performed by the display scaling application 325 may be determined by an analysis of the metadata of the content and by performing a heuristic analysis. The reflowing operation performed by the display scaling application 325 may also be applied when a user changes the size of a browser window instead of changing the orientation of the GUI 402. For example, a browser window having first portrait dimensions may be changed by user input to display with second browser dimensions different from the first browser dimensions. In this example, the display scaling application 325 may reflow the content to account for the change in size of the browser window.

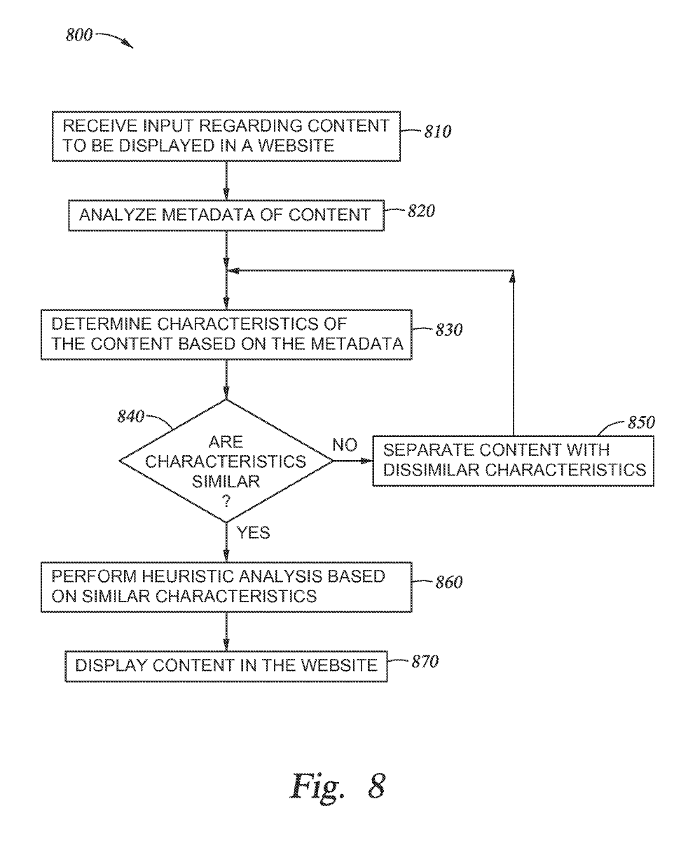

FIG. 8 is a schematic flow chart 800 depicting a display scaling application receiving input and displaying content within a website. The display scaling application may be an integral feature of a user's own website and may automatically determine the display of content within the website. At operation 810, the display scaling application may receive input from a user regarding content to be displayed in the website. The content may be any type of content typically displayed in a website and may be provided to the website by any suitable method, such as uploading, downloading, or the like. Upon receiving the content to be displayed, the display scaling application may analyze the metadata of the content provided to the website. The display scaling application may automatically analyze the metadata of the content at operation 820 without receiving additional input from the user.

At operation 830, the display scaling application may determine characteristics of the content based on the metadata of the content. The characteristics may be any type of unique characteristics which may differentiate one type of content from another type of content. Examples of characteristics which may differentiate content are provided in the above description with regard to FIG. 5. At operation 840, the display scaling application may determine whether characteristics of the content are similar or different. If the characteristics of certain content items are different, the display scaling application may segregate those content items at operation 850. The separated content items may then be reanalyzed by the display scaling application to determine if other content provided to the website shares similar characteristics. This process may be repeated until the display scaling application determines characteristic groups for displaying the content within the website.

If the characteristics of the content are similar, the display scaling application may perform a heuristic analysis based on the similar characteristics of the content at operation 860. The heuristic analysis may be based on various factors, such as display efficiency and aesthetics, to determine a desirable display of the content. The display scaling application may also learn a user's preferences and apply the user's preferences during the heuristic analysis to display the content. At operation 870, the content may be displayed in the website. The display of the content within the website may be efficient and aesthetically pleasing as a result of the analysis performed on the content by the display scaling application. Each time the user provides new content, removes content, or rearranges content within the website, the display scaling application may perform operations 810-870 to determine an optimized content display.

While the foregoing is directed to embodiments of the present disclosure, other and further embodiments of the disclosure may be devised without departing from the basic scope thereof. For example, aspects of the present disclosure may be implemented in hardware or software or in a combination of hardware and software. One embodiment of the disclosure may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present disclosure, are embodiments of the present disclosure. Therefore, the scope of the present disclosure is determined by the claims that follow.

1. A method of performing display scaling, comprising:
receiving input regarding content to be displayed in a website having a content area;
analyzing metadata of the content after receiving the input;
determining characteristics of the content based on the metadata;
applying a heuristic analysis of the characteristics, wherein the heuristic analysis comprises determining a layout of the content to the displayed on the website that results in multiple content items to be displayed that have different sizes and/or orientations without altering the size and/or orientation of the content items and while utilizing greater than about 95 percent of the content area; and
displaying the content in the website.

2. The method of claim 1, wherein analyzing the metadata is performed automatically.

3. The method of claim 1, wherein determining the layout of the content further comprises segregating and arranging individual content items based upon similarities or differences of the metadata.

4. The method of claim 3, wherein the heuristic analysis selects content to be displayed based upon similarities or differences.

5. The method of claim 1, further comprising reflowing the content of the website when size change of a browser is detected.

6. The method of claim 5, wherein the reflowing the content may be applied across multiple webpages.

7. The method of claim 1, wherein unintentional dead space is not displayed among the content in the website.

8. A non-transitory computer-readable storage medium, storing instructions that when executed by a processor, cause the processor to provide display scaling, by performing the steps of:
receiving input regarding content to be displayed in a website;
analyzing metadata of the content after receiving the input;
determining characteristics of the content based on the metadata;
applying a heuristic analysis of the characteristics, wherein the heuristic analysis comprises determining a layout of the content to the displayed on the website that results in multiple content items to be displayed that have different sizes and/or orientations without altering the size and/or orientation of the content items and while utilizing greater than about 95 percent of the content area; and
displaying the content in the website.

9. The non-transitory computer-readable storage medium of claim 8, wherein analyzing the metadata is performed automatically.

10. The non-transitory computer-readable storage medium of claim 8, wherein determining the layout of the content further comprises segregating and arranging individual content items based upon similarities or differences of the metadata.

11. The non-transitory computer-readable storage medium of claim 10, wherein the heuristic analysis selects content to be displayed based upon similarities or differences.

12. The non-transitory computer-readable storage medium of claim 8, further comprising reflowing the content of the website when size change of a browser is detected.

13. The non-transitory computer-readable storage medium of claim 12, wherein the reflowing the content may be applied across multiple webpages.

14. The non-transitory computer-readable storage medium of claim 8, wherein unintentional dead space is not displayed among the content in the website.

15. A computer system for providing display scaling, comprising:
a processor; and
a memory storing instructions that, when executed by the processor, cause the computer system to:
receive input regarding content to be displayed in a website;
analyze metadata of the content after receiving the input;
determine characteristics of the content based on the metadata;
apply a heuristic analysis of the characteristics, wherein the heuristic analysis comprises determining a layout of the content to the displayed on the website that results in multiple content items to be displayed that have different sizes and/or orientations without altering the size and/or orientation of the content items and while utilizing greater than about 95 percent of the content area; and
display the content in the website.

16. The computer system of claim 15, wherein analyzing the metadata is performed automatically.

17. The computer system of claim 15, wherein determining the layout of the content further comprises segregating and arranging individual content items based upon similarities or differences of the metadata.

18. The computer system of claim 17, wherein the heuristic analysis selects content to be displayed based upon similarities or differences.

19. The computer system of claim 15, further comprising reflowing the content of the website when size change of a browser is detected.

20. The computer system of claim 19, wherein the reflowing the content may be applied across multiple webpages.

21. The computer system of claim 15, wherein unintentional dead space is not displayed among the content in the website.
